(19) United States
(12) Patent Application Publication
(10) Pub. No.: US 2014/0042209 A1
(43) Pub. Date: Feb. 13, 2014

(54) METHOD FOR MANUFACTURING A SPIRAL GROOVE METAL PIPE WITH A SYMMETRICAL STRUCTURE

(71) Applicant: Tae Hun CHOI, Siheung-si (KR)

(72) Inventor: Tae Hun CHOI, Siheung-si (KR)

(21) Appl. No.: 13/939,054

(22) Filed: Jul. 10, 2013

(30) Foreign Application Priority Data
Aug. 8, 2012 (KR) 10-2012-0095586

(51) Int. Cl. F16L 9/02

(52) U.S. Cl. CPC F16L 9/02
USPC 228/159

(57) ABSTRACT

A method for manufacturing a spiral groove metal pipe with a symmetrical structure comprises the steps of: supplying a metal strip successively; forming spiral grooves on the upper surface of the metal strip supplied at the metal strip supplying step in which the spiral grooves are repeatedly and symmetrically formed as the same pattern from side to side with the middle as the center with a shape of ‘ [symbol] ’ symmetrically; forming a pipe in which its inner surface has spiral grooves formed at the spiral groove forming step and its outer surface has a smooth surface; welding the metal strip at the pipe forming step in such a way that opposite edges of the metal strip meet each other; and removing welding beads produced in the inner and outer surfaces of the metal strip by the welding step.

### BACKGROUND OF THE INVENTION

1. Field of the Invention

The present invention relates, in general, to a method for manufacturing a spiral groove metal pipe with a symmetrical structure, and, more particularly, to a method for manufacturing a spiral groove metal pipe with a symmetrical structure in which spiral grooves are formed in the inner surface of a metal pipe cylindrically formed through an extrusion molding by a metal pipe forming apparatus, thereby reinforcing the overall strength of the entire metal pipe.

2. Description of the Related Art

Generally, a metal pipe has flat inner and outer circumferential surfaces and is used as an exhaust pipe, a drain pipe, a waste water pipe, a water service pipe, and a construction material etc.

Metal pipes are manufactured by bending a general thin metal plate round and then by welding contact edges.

According to a related art, Korean Patent No. 10-0874036, a method for manufacturing a spiral groove metal pipe comprises the steps of: forming spiral grooves in which a plurality of spiral grooves are formed repeatedly with the same pattern in a side surface of a material, ends of the spiral grooves have a predetermined curvature, and among the spiral grooves, the rear end of a spiral groove and the front end of another spiral groove are formed in such a way that spirals of the spiral grooves are formed in a continuous direction when the material is formed as a pipe; forming a pipe, in which, at the spiral groove forming step, the side surface of the material on which the spiral grooves are formed becomes an inner surface of the pipe, its outer surface has a smooth surface, and its cross-sectional shape is formed as a pipe to be a complete circle in shape; welding both first and second edges of the material so as to be in contact with each other; and removing welding beads produced in the inside of the pipe during the welding step.

FIGS. 1A to 1D are views for explaining a method for manufacturing a spiral groove metal pipe according to a conventional art.

As described above, in the spiral groove metal pipe manufacturing method according to the conventional art, there are several disadvantages: a twist phenomenon in the material takes place by a right or left twist angle according to the direction of spiral grooves, so it is difficult to cylindrically form the material, and flaws in welding frequently occur because a welding line is not constant.

Also, in the conventional spiral groove metal pipe manufacturing method, a lean phenomenon in which slanting in a shaft direction occurs, wherein the pipe cannot bear the weight of the shape, so that not only the cutting phenomenon of the pipe occurs, but also overload occurs in a motor and a reducer. Due to these phenomena, patterns formed on surfaces of the shaft, bearing, and roller of a mechanical instrument are destroyed, and productivity is also reduced, so it is difficult to manage a maintenance cost at the production installations.

Also, in the conventional spiral metal pipe manufacturing method, due to a spiral groove having a twist angle mixed with the right and left directions, a bending phenomenon takes place at the outer circumferential surface of the material, thereby forming an uneven curved surface, not a smooth surface.

### SUMMARY OF THE INVENTION

Accordingly, the present invention has been made keeping in mind the above problems occurring in the related art, and the present invention is intended to propose a method for manufacturing a spiral groove metal pipe with a symmetrical structure in which spiral grooves are formed in the inner surface of a metal pipe cylindrically formed through an extrusion molding by a metal pipe forming apparatus, thereby reinforcing the overall strength of the entire metal pipe.

In order to achieve the above object, according to one aspect of the present invention, there is provided a method for manufacturing a spiral groove metal pipe with a symmetrical structure comprising the steps of: supplying a metal strip successively; forming spiral grooves on the upper surface of the metal strip supplied at the metal strip supplying step in which the spiral grooves are repeatedly and symmetrically formed as the same pattern from side to side with the middle as the center with a shape of ‘ [symbol] ’ symmetrically; forming a pipe in which its inner surface has spiral grooves formed at the spiral groove forming step and its outer surface has a smooth surface; welding the metal strip in such a way that opposite edges of the strip meet with each other; and removing welding beads produced in the inner and outer surfaces of the metal strip by the welding step.

Preferably, according to an embodiment of the present invention, in the spiral groove forming step, a twist angle of spiral grooves with a shape of ‘ [symbol] ’ formed on the upper surface of the metal strip is formed symmetrically between 0° to 90° with the middle as the center. More preferably, according to an embodiment of the present invention, in the spiral groove forming step, spiral grooves formed in the metal strip are repeatedly famed with a shape of ‘ [symbol] ’ instead of a shape of ‘ [symbol] ’, or formed with a diamond shape by crossing different twist angles alternately with a shape of ‘ [symbol] ’ and a shape of ‘ [symbol] ’ to be distributed the crossing points evenly.

More preferably, according to an embodiment of the present invention, spiral grooves formed in the metal strip with a shape of ‘ [symbol] ’ are first formed, and thereafter, spiral grooves with the shape of ‘ [symbol] ’ are formed, thereby forming the spiral grooves with a diamond shape by crossing them with different twist angles.

According to the method for manufacturing a spiral groove metal pipe with a symmetrical structure, there are several advantages: spiral grooves are formed in the inside of a metal pipe cylindrically and symmetrically formed with the middle as the center through an extrusion molding by a metal pipe forming apparatus, thereby reinforcing overall durability of the entire metal pipe, such as tensile strength, yield strength and elongation percentage etc. and the pipe is easily formed and a welding line is formed so as to be maintained constant.

Also, according to the method for manufacturing a spiral groove metal pipe with a symmetrical structure, spiral grooves are symmetrically formed in the inside of the metal pipe with the middle as the center, so that the shaft weight of the mechanical instruments is concentrated at the center of the shaft toward the spiral grooves, thereby making the metal pipe stable and balanced, protecting the rotating shaft, preventing the breakdown of the mechanical instruments or defects being generated therein, increasing productivity, and lowering the cost.

Also, according to the method for manufacturing a spiral groove metal pipe with a symmetrical structure, spiral grooves formed in the metal strip are formed by crossing different twist angles alternately with a shape of ‘ [symbol] ’ and a shape of ‘ [symbol] ’ to be distributed the crossing points evenly, so that the outer circumferential surface of the metal pipe is formed to have a smooth surface.

### BRIEF DESCRIPTION OF THE DRAWINGS

The above and other objects, features and other advantages of the present invention will be more clearly understood from the following detailed description when taken in conjunction with the accompanying drawings, in which:

FIGS. 1A to 1D are views for explaining a method for manufacturing a spiral groove metal pipe according to a conventional art;

FIG. 2 is a view for explaining a method for manufacturing a spiral groove metal pipe with a symmetrical structure according to the present invention;

FIGS. 3A to 3C are views for explaining several examples in the forming step in a method for manufacturing a spiral groove metal pipe with a symmetrical structure according to the present invention; and

FIG. 4 is a process flow chart of a method for manufacturing a spiral groove metal pipe with a symmetrical structure according to the present invention.

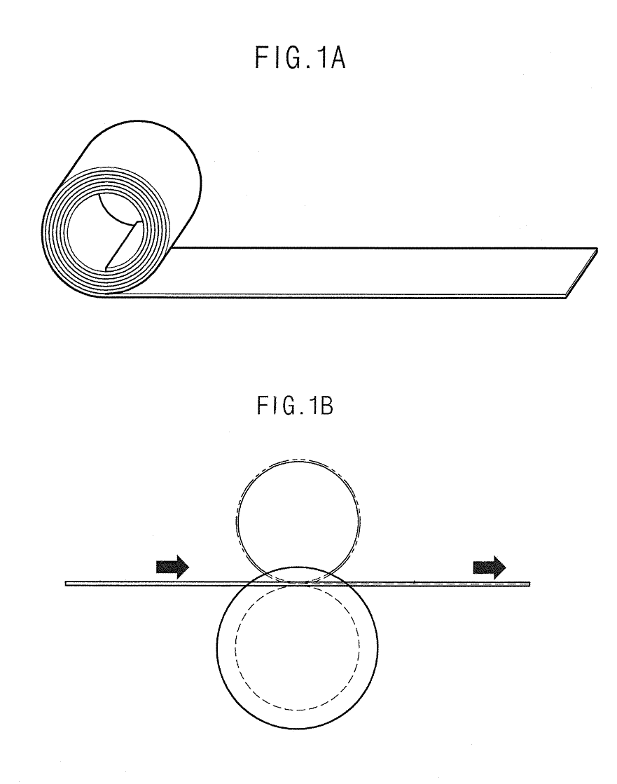

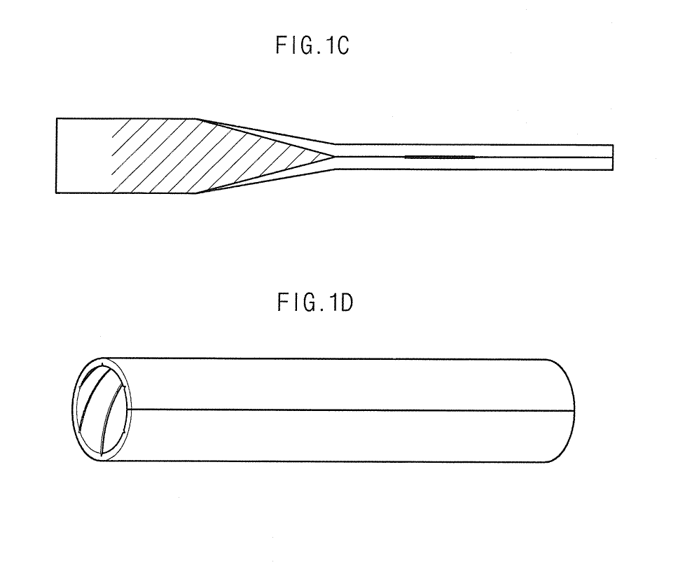

### DETAILED DESCRIPTION OF THE INVENTION

Reference will now be made in greater detail to a preferred embodiment of the invention, an example of which is illustrated in the accompanying drawings.

However, it should be understood that the embodiment of the present invention may be changed to a variety of embodiments and the scope and spirit of the present invention are not limited to the embodiment described hereinbelow. The embodiment of the present invention described hereinbelow is provided to allow those skilled in the art to more clearly comprehend the present invention.

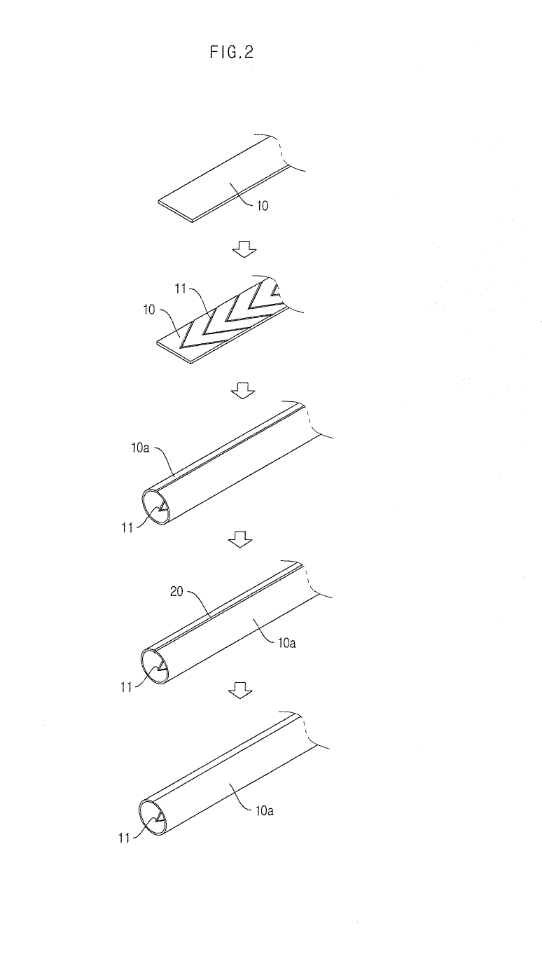

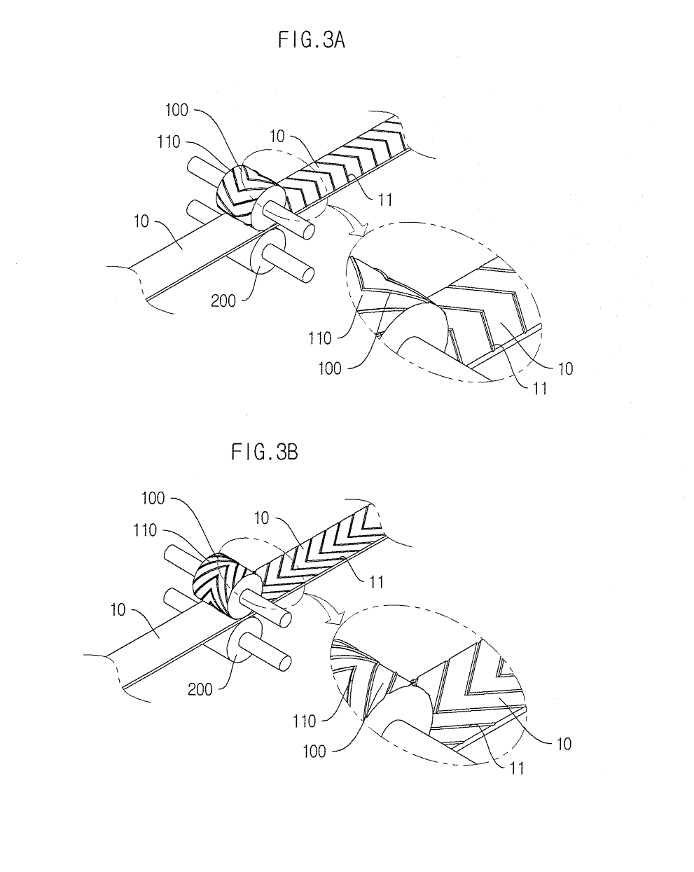

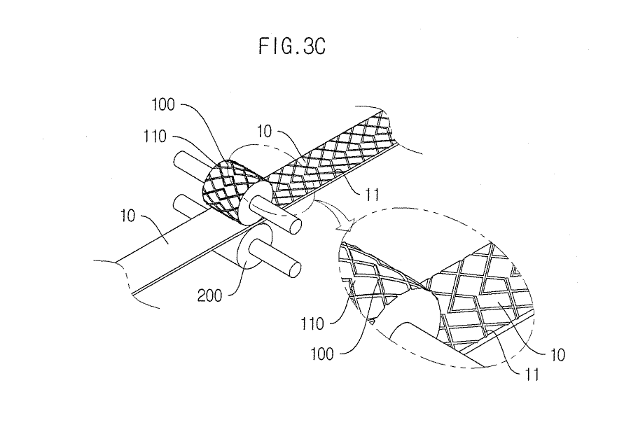

Hereinafter, a method for manufacturing a spiral groove metal pipe with a symmetrical structure according to an embodiment of a present invention will be described in detail with reference to the accompanying drawings of FIG.2 and FIGS. 3A to 3C.

As shown in FIG. 2, a method for manufacturing a spiral groove metal pipe with a symmetrical structure according to a present invention comprises the steps of: supplying a metal strip 10 successively; forming spiral grooves 10 on the upper surface of the metal strip supplied at the metal strip supplying step in which the spiral grooves are repeatedly and symmetrically formed as the same pattern from side to side with the middle as the center with a shape of ‘ [symbol] ’ symmetrically; forming a pipe in which the inner surface of the pipe has spiral grooves 11 formed at the spiral groove forming step and its outer surface of the pipe has a smooth side; welding the metal strip at the pipe forming step in such a way that opposite edges of the metal strip meet with each other; and removing welding beads 20 produced on the inner and outer surfaces of the metal strip 10 at the welding step.

Here, the metal strip supplying step plays a role of supplying a metal strip 10 to a spiral groove forming step, and the metal strip 10 will be processed into a metal pipe 10a and the process will be explained hereinafter. The metal strip 10 is formed as a plate shape with a flat plane and bottom.

In the spiral groove forming step, spiral grooves with the shape of ‘ [symbol] ’ are extruded on the metal strip 10 supplied by the above-described metal strip supplying step, and the metal strip 10 is passed between a first forming roller 100 and a second forming roller 200, whereby the spiral grooves 11 are repeatedly and symmetrically formed as the same pattern from side to side with the middle of the upper surface of the metal strip as the center.

More specifically, as shown in FIG. 3A, the first forming roller 100, in which forming protrusion lines 110 protruded with a shape of ‘ [symbol] ’ are formed repeatedly and symmetrically at the outer circumferential surface as the same from side to side with the middle as the center, pressurizes the metal strip while rotating. The metal strip 10 passes between the first forming roller 100 and the second forming roller 200 with a flat outer circumferential surface, so that spiral grooves with a shape of ‘ [symbol] ’ are formed on the upper surface of the metal strip 10 by the extrusion molding, and a twist angle of the forming protrusion line 110 is formed symmetrically between 0° to 90° with the middle as the center.

At this time, the forming protrusion lines 110, as shown in FIG. 3B, may be protruded with a shape of ‘ [symbol] ’ to the opposite direction, or may be formed with a diamond shape, as shown in FIG. 3C, by crossing different twist angles alternately with a shape of ‘ [symbol] ’ and a shape of ‘ [symbol] ’ to be distributed the crossing points evenly.

For example, in case that the twist angle of the shape of ‘ [symbol] ’ is 45°, it is desirable that in the forming protrusion lines 110 with a diamond shape, the twist angle of the shape of ‘ [symbol] ’ is formed symmetrically between 0° to 90° with the middle as the center not to be met crossing points.

Also, the first forming roller 100 and the second forming roller 200 as shown in FIG. 3A and the first forming roller 100 and the second forming roller as shown in FIG. 3B may be arranged successively, spiral grooves 11 formed at the spiral groove forming step are formed first with a shape of ‘ [symbol] ’ and then formed with a shape of ‘ [symbol] ’ as the opposite direction of the spiral grooves with the shape of ‘ [symbol] ’, thereby forming spiral grooves with a diamond shape crossed on the upper surface of the metal strip. As described above, forming protrusion lines must be formed with a diamond shape by crossing different twist angles alternately with the shape of ‘ [symbol] ’ and the shape of ‘ [symbol] ’ to be distributed at the crossing points evenly.

The width and depth of the spiral grooves formed on the upper surface of the metal strip 10 are formed to be 10% to 15% relative to a thickness of the metal strip 10 so as to form a smooth surface in order not form protrusions at the bottom of the metal strip. The width of the spiral grooves is formed between 1 mm to 10 mm so as to allow smooth interaction with fluid (gas or liquid).

The width and depth of the spiral grooves formed on the upper surface of the metal strip 10 with a diamond shape are not limited by the above description and they can be changed according to mechanical characteristics of the metal strip 10, especially, malleability and ductility etc.

The metal strip 10 with spiral grooves 11 formed at the spiral groove forming step is transferred to a pipe forming step. In the pipe forming step, a pipe is formed as a complete circle, so that its inner surface has spiral grooves 11 formed with a shape of ‘ [symbol] ’ and a shape of ‘ [symbol] ’, or a diamond shape on the upper surface of the metal strip 10 at the spiral groove forming step and its outer surface has a smooth surface. The pipe forming step of the present invention is the same as that of the conventional art, and so the repeated explanations will be omitted to simplify the specification.

In the pipe forming step, a welding step for welding the metal strip 10 to be formed into a pipe is carried out, the wherein the edges of the metal strip 10 are arranged so as to be in contact, and then welding is performed so as to be form the metal pipe 10a. As welding techniques, at this time, high-frequency welding and argon welding etc. are used. The welding step of the present invention is the same as that of the conventional art, and so the repeated explanations will be omitted to simplify the specification.

The welding beads 20 generated by the welding step are removed in the welding bead removing step. In the welding bead removing step, when welding, welding beads 20 generated in the inner and outer surfaces of the contact edges of the metal strip 10 are removed by a bite and a sand paper etc. according to the metal material or may be removed by a grinder.

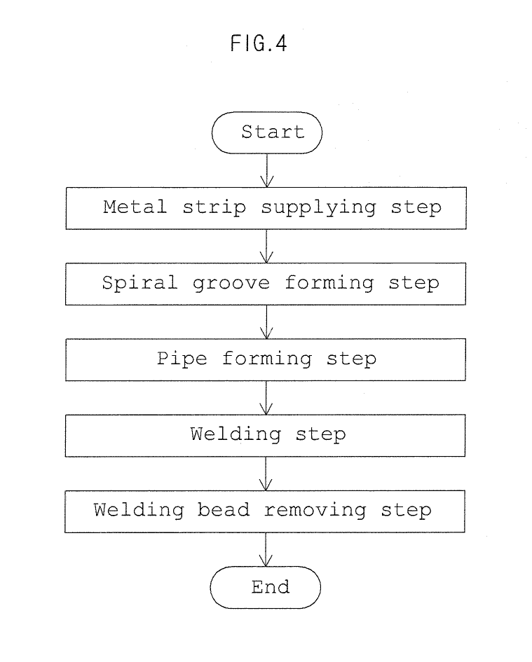

Hereinafter, an entire manufacturing process of a spiral groove metal pipe with a symmetrical structure according to the embodiment of the present invention will be described with reference to FIG. 4.

First, as a supply step, metal strips 10 to be processed into metal pipes 10a are supplied successively from a supplying part.

At this time, a spiral groove forming step of the metal strip 10 supplied from the supplying step is performed. In the spiral groove forming step, spiral grooves are formed on the metal strip 10 extruded by the first forming roller 100 and the second forming roller 200 with a shape of ‘ [symbol] ’, a shape of ‘ [symbol] ’, or a diamond shape.

Thereafter, the metal strip 10 having spiral grooves 11 with a shape of ‘ [symbol] ’, a shape of ‘ [symbol] ’, or a diamond shape is transferred to a pipe forming step.

Also, thereafter, in the pipe forming step, a pipe is formed as a complete cylinder, so that its inner surface has spiral grooves 11 formed with a shape of ‘ [symbol] ’ and a shape of ‘ [symbol] ’, or a diamond shape on the upper surface of the metal strip 10 at the spiral groove forming step and its outer surface has a smooth surface. Thereafter, the pipe forming step is finished and the pipe is then transferred to a welding step.

The metal strip 10 transferred from the pipe forming step is welded and processed to the metal pipe 10a and at this time, the welding beads 20 generated by welding are formed on the inner and outer surfaces of both contact edges of the metal strip 10 and then the welding step is transferred to a welding bead removing step.

In the welding step, a welding bead removing step for removing welding beads 20 generated in the inner and outer surfaces of both contact sides of the metal strip is performed.

As described above, when the welding beads are removed, the metal pipe 10a is completed and then may be cut to a predetermined length by a generally known conventional art and outputted. The cut metal pipes are cut, welded or bent according to uses and the needs of customers.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method for manufacturing a spiral groove metal pipe with a symmetrical structure comprising the steps of:
supplying a metal strip successively;
forming spiral grooves on an upper surface of the metal strip supplied at the metal strip supplying step in which the spiral grooves are repeatedly and symmetrically formed as the same pattern from side to side with a middle as a center with a shape of ‘ [symbol] ’ symmetrically;
forming a pipe in which its inner surface has the spiral grooves formed at the spiral groove forming step and an outer surface of the pipe has a smooth surface;
welding the metal strip at the pipe forming step in such a way that opposite edges of the metal strip meet with each other; and
removing welding beads produced on the inner and outer surfaces of the metal strip at the welding step,
wherein in the spiral groove forming step, spiral grooves formed in the metal strip are repeatedly formed with a shape of ‘ [symbol] ’ instead of the shape of ‘ [symbol] ’, or formed with a diamond shape by crossing different twist angles alternately with a shape of ‘ [symbol] ’ and a shape of ‘ [symbol] ’ to be distributed at the crossing points evenly, spiral grooves formed in the metal strip with the shape of ‘ [symbol] ’ are first formed, and thereafter, spiral grooves with the shape of ‘ [symbol] ’ are formed, thereby forming the spiral grooves with a diamond shape by crossing them with different twist angles.

2. The method according to claim 1, wherein in the spiral groove forming step, a twist angle of spiral grooves with the shape of ‘ [symbol] ’ formed on the upper surface of the metal strip is formed symmetrically between 0° to 90° with the middle as the center.
